(19) United States
(12) Patent Application Publication
(10) Pub. No.: US 2017/0061079 A1
(43) Pub. Date: Mar. 2, 2017

(54) TREATMENT MANAGEMENT SYSTEM AND METHOD

(71) Applicant: J. William LaValley, Austin, TX (US)

(72) Inventor: J. William LaValley, Austin, TX (US)

(21) Appl. No.: 15/253,314

(22) Filed: Aug. 31, 2016

Related U.S. Application Data
(60) Provisional application No. 62/213,281, filed on Sep. 2, 2015.

(51) Int. Cl. G06F 19/00; G06F 17/30

(52) U.S. Cl. CPC G06F 19/325; G06F 19/345; G06F 17/30867

(57) ABSTRACT

A computer implemented method of optimizing delivery of treatment management plans. The method includes receiving an input identifier of a diagnosis by a store processor, processing by the store processor each of a dietary therapy store, a medical therapy store, a natural product supplement therapy store, a bioenergetics/bioinformation therapy store, a physical activity therapy store, a mental and emotional therapy store, an environmental exposure therapy store, a precautions and consents store, and a costs store, to determine recommendations of each store, and outputting a treatment management plan formatted by categories of each store. The method may also include retrieving from at least one data source device, over a communications network, treatment recommendations of the at least one data source device, translating the treatment recommendations to common language and syntax format, parsing the treatment recommendations from the step of translating to assign respective tags to the treatment recommendations, respectively, and storing the tags, respectively, in each corresponding one of the dietary therapy store, the medical therapy store, the natural product supplement therapy store, the bioenergetics/bioinformation therapy store, the physical activity therapy store, the mental and emotional therapy store, the environmental exposure therapy store, the precautions and consents store, and the costs store, respectively.

### TECHNICAL FIELD

The invention generally relates to devices and device operations for management of treatment options for a patient, and more particularly relates to computer implemented systems and methods for computer and database organization and operation for delivering structured treatment options and management of treatment from among the options available to patients.

### BACKGROUND

Conventionally, medical doctors and other health care professionals attend schools for a number of years, to study symptoms, cures and medical and health care treatments for a wide spectrum of diseases, illness symptoms and health care problems. Health and medical diagnoses become increasingly complex as better understanding of illness and disease is gained. An ever growing data set of health and disease information, and complexity of the information, makes it difficult for doctors and other health care professionals to stay abreast of the full range of available relevant research results and therapeutic options.

Optimal treatment management for each particular patient has often been addressed according to overall (e.g., conventional) practices for all patients. This has led to “broad brush” practices in treatment, in which cases of a particular disease or illness are treated in a substantially same manner. Patient-centered health care recognizes patient individuality and patient preference as relevant determinants driving treatment decisions. Precision medicine practice includes the utilization of patient-specific molecular laboratory data to indicate individualized treatment recommendations for patients with similar diagnoses and similar symptoms. Physicians, and the patients they treat, increasingly seek patient-centered, precision medicine optimal treatment solutions.

A more holistic approach to treatment management, with consideration and availability of options from among a spectrum of disciplines, better recognizes the uniqueness of each individual patient. Although conventional medicine (with its many sub-specialties) and complementary medicine (including homeopathy, osteopathy, chiropractic, dentistry, acupuncture, massage, herbal medicine, nutritional therapy and other therapies) are available, a practical, efficient treatment management solution has not automatedly integrated these therapy practices and treatment recommendations with specific focus on needs of the individual patient. A more thorough treatment management solution would account for all disciplines and practices, to optimize the individual patient's treatment options and treatment management.

It would therefore be an improvement to provide systems and methods of computer and database organization, integration and operation, by select categories, for delivering various treatment options that are available in each particular instant, in order to implement optimal treatment management plans. The optimal treatment management plans so implemented through the systems and methods may include, but are not limited to, medical treatment management plans. It would also be an improvement to optimize computer and database organization and operations for delivering treatment management plans by including cost considerations, health care provider preferences, patient preferences, and payor considerations.

### SUMMARY

An embodiment of the invention is a system for optimizing delivery of a treatment management plan, including a dietary therapy store, a medical therapy store, a natural product supplement therapy store, a bioenergetics/bioinformation therapy store, a physical activity therapy store, a mental and emotional therapy store, an environmental exposure therapy store, a precautions and consents store, a costs store, a store processor communicatively connected to the dietary therapy store, the medical therapy store, the natural product supplement therapy store, the bioenergetics/bioinformation therapy store, the physical activity therapy store, the mental and emotional therapy store, the environmental exposure therapy store, the precautions and consents store, and the costs store, and memory communicatively connected to the store processor.

Another embodiment of the invention is a system for delivering a treatment management plan. Treatment options for the plan are available from at least one data source device. The system includes a retriever device communicatively connected to each of the at least one data source device, the retriever device accesses treatment recommendations of the at least one data source device, a reader device communicatively connected to the retriever device translates the treatment recommendations from the retriever device to common language and syntax format, a parser communicatively connected to the reader device assigns respective tags to the treatment recommendations, respectively, the tags, respectively, correspond to pluralities of stores, respectively, a segregator device communicatively connected to the parser stores the tags, respectively, in corresponding ones of the stores, respectively, and a database communicatively connected to the segregator device includes the plurality of stores.

Yet another embodiment of the invention is a method of optimizing delivery of a treatment management plan. The method includes receiving an input identifier of a diagnosis by a store processor, processing by the store processor each of a dietary therapy store, a medical therapy store, a natural product supplement therapy store, a bioenergetics/bioinformation therapy store, a physical activity therapy store, a mental and emotional therapy store, an environmental exposure therapy store, a precautions and consents store, and a costs store, to determine recommendations of each store, and outputting by the store processor the treatment management plan formatted by categories of each store.

Another embodiment of the invention is a method of delivering treatment management plans. The method includes retrieving by a processor from at least one data source device, over a communications network, treatment recommendations of the at least one data source device, translating by the processor the treatment recommendations to common language and syntax format, parsing by the processor the treatment recommendations from the step of translating to assign respective tags to the treatment recommendations, respectively, and storing the tags, respectively, by the processor, in each corresponding one of a dietary therapy store, a medical therapy store, a natural product supplement therapy store, a bioenergetics/bioinformation therapy store, a physical activity therapy store, a mental and emotional therapy store, an environmental exposure therapy store, a precautions and consents store, and a costs store, respectively.

Yet another embodiment of the invention is a data storage and retrieval system for a computer memory, for delivering a treatment management plan. The data storage and retrieval system includes a dietary therapy store, a medical therapy store, a natural product supplement therapy store, a bioenergetics/bioinformation therapy store, a physical activity therapy store, a mental and emotional therapy store, an environmental exposure therapy store, a precautions and consents store, a costs store. Each of the stores includes a plurality of respective records, which respective records are inferentially related to other of the plurality of respective records of other store(s). A store processor is communicatively connected to each of the stores and indexes respective records of each of the stores. Memory is communicatively connected to the store processor.

### BRIEF DESCRIPTION OF THE DRAWINGS

The present invention is illustrated by way of example and not limitation in the accompanying figures, in which like references indicate similar elements, and in which:

FIG. 1 illustrates a system for optimizing delivery of a treatment management plan, according to certain embodiments;

FIG. 2 illustrates a system for collecting recommendations for respective stores for optimizing delivery of a treatment management plan, according to certain embodiments;

FIG. 3 illustrates a method for optimizing delivery of a treatment management plan, according to certain embodiments;

FIG. 4 illustrates a method for collecting recommendations for respective stores and for optimizing delivery of a treatment management plan of categories corresponding to the stores, according to certain embodiments; and

FIG. 5 illustrates a data storage and retrieval system for a computer memory, for optimizing delivery of a treatment management plan, according to certain embodiments.

### DETAILED DESCRIPTION

The following description refers to certain specific embodiments; however, the specific embodiments are merely illustrative and variations and changes may be made in the embodiments without diverting from the broad scope encompassed by the disclosure. For purposes of the following detailed description and examples:

A “diagnosis” is an identifier of a disease, illness, malady or other health condition or status of a patient, as determined by a physician or relevant care provider. The identifier is, by way of non-exclusive example, a designation of International Classification of Diseases as ICD9 and ICD10 diagnoses for such a disease, illness, malady or condition, or other health assessment indices or information.

A “recommendation” is an article, tag, or other piece of content relevant to a particular diagnosis or patient condition or status.

A “store” is an item or collection of items stored in a non-transitory memory, for example, a relational or other database.

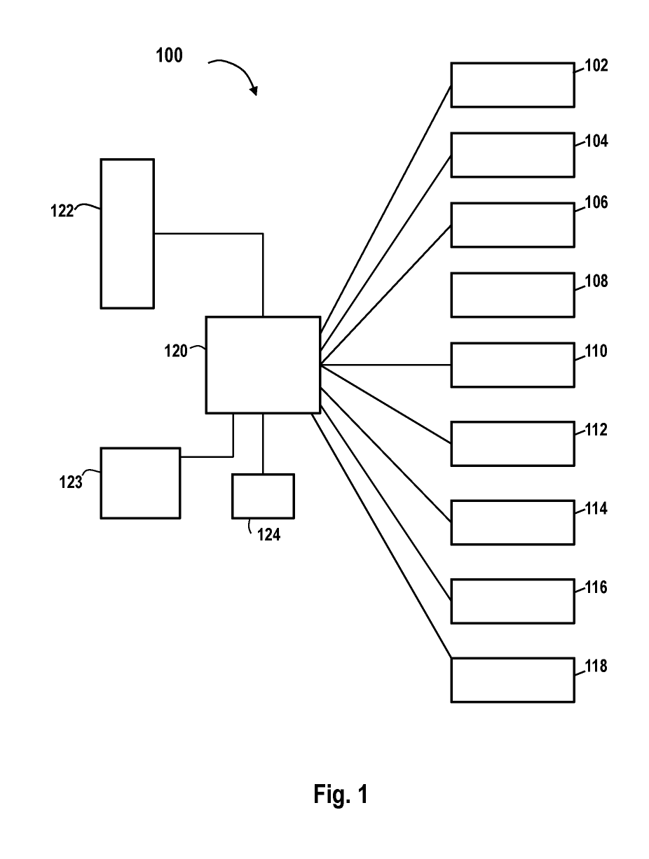

Referring to FIG. 1, a system 100 includes a dietary therapy store 102, a medical therapy store 104, a natural product supplement therapy store 106, a bioenergetics/bioinformation therapy store 108, a physical activity therapy store 110, a mental and emotional therapy store 112, an environmental exposure therapy store 114, a precautions and consents store 116, and a costs store 118. The system also includes a store processor 120 and memory 122 communicatively connected to the store processor 120. The store processor 120 is communicatively connected to the dietary therapy store 102, the medical therapy store 104, the natural product supplement therapy store 106, the bioenergetics/bioinformation therapy store 108, the physical activity therapy store 110, the mental and emotional therapy store 112, the environmental exposure therapy store 114, the precautions and consents store 116 and the costs store 118.

The respective stores 102, 104, 106, 108, 110, 112, 114, 116 and 118 organize treatment management option recommendations, to efficiently cover the entire spectrum of health care options available in a health care setting. In particular, the dietary therapy store 102 includes recommendations of consumable foods and fluids, including functional foods and drinks, as well as other nutritional consumables not specified in others of the stores. The medical therapy store 104 includes recommendations of prescription pharmaceuticals, over-the-counter pharmaceuticals, surgery, other invasive treatment procedures, x-ray radiation, non-ionizing radiation, hospital-based medical treatments, medically insured medical treatments, and non-insured medical treatments. The natural product supplement therapy store 106 includes recommendations of food supplements as defined by the Dietary Supplement Health and Education Act of 1994 (DSHEA) in the U.S. and within the definition of natural health product in Canada.

Further, the bioenergetics/bioinformation therapy store 108 includes recommendations of unconventional, alternative and complementary medicine and healthcare treatments, for example but not limited to, homeopathic medicine (classical, complex and electronically-derived homeopathy), electro-dermal screening or assessment, bioinformational therapy and direct or indirect electromagnetic, bioenergetic or bioinformational procedure, process or device providing electromagnetic information transfer (including but not limited to light, sound therapy, electromagnetic frequency and massless information transfer therapy). The physical activity therapy store 110 includes recommendations of self-directed movement, for example but not limited to, exercise, stretching, yoga, Pilates, walking, resistance training, and others, and includes physical manipulation, for example but not limited to, chiropractic manipulation, physical therapy and massage therapy. The mental and emotional therapy store 112 includes recommendations for psychological, mental, emotional, behavioral, cognitive, intellectual, attitudinal, cultural and psychosocial treatment. The environmental exposure therapy store 114 includes recommendations for management of exposures to, and therapy regarding, environmental stressors, microbial and infectious exposures, toxins, irritants, home contaminants, adverse molecules, adverse sensory stimuli, adverse electromagnetic exposure, adverse industrial exposure, adverse home exposure, and other adverse community exposure.

Furthermore, the precautions and consents store 116 includes recommendations of cautions about drug interactions, other adverse treatment effects and side effects including, and not limited to, treatment intolerances, allergies, physical, chemical, mental, emotional and other adverse effects and other warnings, as well as documentation for providing and obtaining valid consent for treatments including, and not limited to, surgical procedures, invasive procedures, radiation and other energetic therapy procedures, pharmaceutical and natural product molecular interaction information for identifying and managing potential undesirable adverse interaction effects and potential desirable beneficial interaction effects. The costs store 118 includes recommendations of expenses associated with treatment recommendations of the other stores 102, 104, 106, 108, 110, 112, 114, 116.

In operation, the store processor 120, in conjunction with the memory 122 and based on external input of a request for recommendation (e.g., direct via an input peripheral device or indirect via another processor device), processes the stores 102, 104, 106, 108, 110, 112, 114, 116, 118. The request for recommendation includes, for example, an identifier of an illness, disease, malady or health status of a patient, as non-exclusive example, according to International Classification of Diseases ICD9 and ICD10 diagnoses. The request for recommendation may also, but need not necessarily, include personal preference indicators or client preference indicators for the applicable patient or other client, which personal preference indicators or client preference indicators may preferentially select or reject recommendations of particular store(s) 102, 104, 106, 108, 110, 112, 114, 116, or 118.

Responsive to the input request, the store processor 120, in conjunction with the memory 122, retrieves from the stores 102, 104, 106, 108, 110, 112, 114, 116, 118 the recommendations of those stores corresponding to the input request. An output device 123, such as, for example, a display, printer or other peripheral device, communicatively connected to the store processor 120 delivers the resulting recommendations according to categories identifiable with the respective stores 102, 104, 106, 108, 110, 112, 114, 116, 118. For the recommendations of the stores 102, 104, 106, 108, 110, 112 and 114, the results include relevant recommendations from the stores 116 and 118. The recommendations of the stores 102, 104, 106, 108, 110, 112, 114, 116 and 118 are stored by the store processor 120 in the memory 122.

The system 100 organizes and provides treatment recommendations based on a diagnosis that is input. The treatment recommendations include the nine sources of the stores 102, 104, 106, 108, 110, 112, 114, 116, 118. Output results of the system 100 for any particular diagnosis, include seven categories of treatment recommendations and one category of precautions and consents, and one category of applicable costs corresponding to the treatment recommendations, respectively. The system 100 may be used by healthcare providers, including but not limited to medicine physicians and other providers, and patients, to organize and provide to patients, providers, health maintenance organizations, health insurers, and other clients, multi-category treatment recommendations, based on the diagnosis and health assessment for a patient or client. Other clients and providers, such as, for non-exclusive example, insurers, payors, health maintenance organizations, preferred provider organizations, medical clinics, other health clinics, medical offices and other health care offices, benefits coordinators, healthcare personnel, and others, may also use the system 100 to obtain treatment management recommendations selected from among the categories of the results.

In certain embodiments, the store processor 120 may communicatively connect to one or more of an input device 124, such as a touch display, mouse, keyboard, other peripheral device, and combinations. Certain of the embodiments include a template, such as a form document displayed in a display device, generated by the store processor 120 in conjunction with the memory 122. Keystrokes of a keyboard, click on a mouse, text in boxes of the template, or other input of the input device 124, signals to the store processor 120 identifiers of diagnosis and other health assessment indices or information in respect of a patient. The template may provide check box options, or other mechanisms for selection, via the input device 124, to permit preferential selection of variables related to the patient, the diagnosis, and other health assessment indices or information.

In operation, the store processor 120 receives a query to the template or other interface, such as may be input by a user operating the input device 124. The query includes at least an indicator of a specific diagnosis or other health assessment indices or information of a patient or client. The query may additionally include health and wellness indicators, as well as related costs, filters and other items, specific to preference, condition or status of the patient or other client.

On receipt of the query, the store processor 120 searches the stores 102, 104, 106, 108, 110, 112, 114, 116, 118 to retrieve recommendations from each of the stores corresponding to the query. The store processor 120, in conjunction with the memory 122, outputs results of search of each of the stores 102, 104, 106, 108, 110, 112, 114, 116, 118. The results are categorized in nine distinct units or categories. More particularly, seven of the categories relate to specific treatment recommendations, plus one of the categories relates to precautions and consents, including relevant warnings, valid consent documentation, and the like, applicable to the treatment recommendations, respectively; and one of the categories relates to costs of, or associated with, the treatment recommendations, respectively. The output results deliver treatment options available within areas of healthcare treatment, as assigned to one or more specific categories.

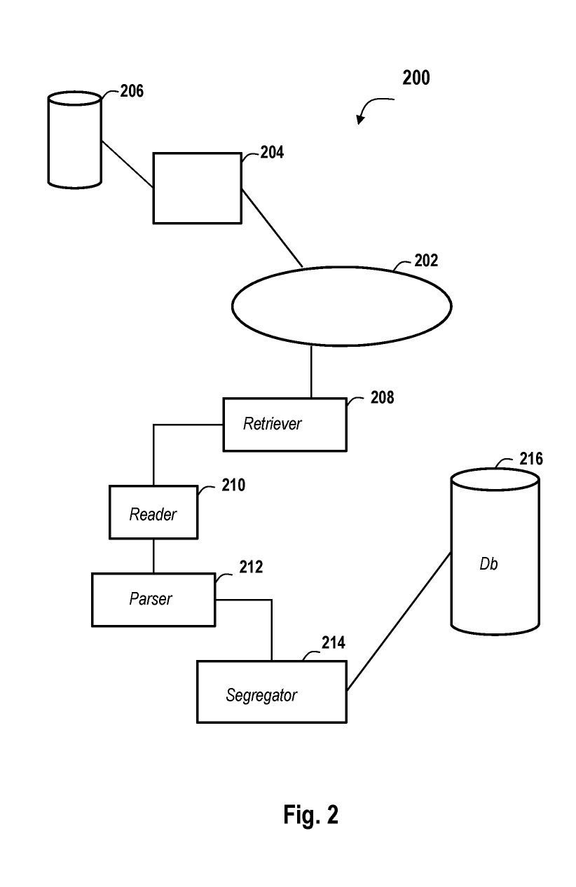

Referring to FIG. 2, a system 200 supplies the stores 102, 104, 106, 108, 110, 112, 114, 116, 118 of the system 100 of FIG. 1 with the recommendations, respectively, for each store. The system 200 includes a retriever device 208. The retriever device 208 may be circuits, software program stored in memory and processed by a processor, and combinations of these. The retriever device 208 is communicatively connected to a data source device 204 via a communications link, for example, a packet-switched or other communications network 202. The data source device 204 may include or communicatively connect to a medical or health database 206. The communications network 202 may be wired, wireless, or combinations, and may include the Internet and/or any other communications links. The retriever device 208 queries the data source device 204 for the recommendations, and receives the recommendations in response to the query.

A reader device 210 is communicatively connected to the retriever device 208. The reader device 210 may be circuits, software program stored in memory and processed by a processor, and combinations. The reader device 210 determines a type of each of the recommendations received by the retriever device 208.

A parser device 212 is communicatively connected to the reader device 210. The parser device 212 may be circuits, software program stored in memory and processed by a processor, and combinations. The parser device 212, responsive to the type(s) of the recommendations from the retriever device 208, determines tags to identify the recommendations, respectively. The tags correspond to one or more categories of a database 216, such as, for example, nine categories (which may correspond to the stores of the system 100 of FIG. 1).

A segregator device 214 is communicatively connected to the parser 212 and to the database 216. The segregator device 214 may be circuits, software program stored in memory and processed by a processor, and combinations. The segregator device 214 writes the tags to the database 216 according to the one or more categories corresponding to each tag.

The database 216 is one or more distinct database, for example, a relational database. The database 216 may be circuits or software program stored in memory and processed by a processor, or combinations of circuits and software program. The database 216 is organized with respective categories as schema. Each category maintains relevant tag(s), as written to the category by the segregator 214. The tags are each a respective indicator of a particular recommendation, respectively.

As a non-exclusive example, the categories are as follows:

I. Treatment recommendations: Categories 1-7
a. Category DI Dietary recommendations—includes information of treatment recommendations for consumable foods and fluids including functional foods and drinks, unless specified in another category.
b. Category RI Medical, pharmaceutical, surgical, and radiation recommendations—includes information of treatment recommendations for prescription pharmaceuticals, over-the-counter pharmaceuticals, surgery or invasive treatment procedure, x-ray radiation, non-ionizing radiation, hospital-based medical treatment, clinic-based medical treatment, medically-insured medical treatment, and non-insured medical treatment, unless specified in another category (for example, but not limited to, acupuncture or acupressure or any directly or indirectly applied electromagnetic therapeutic device or procedure, which instead is sorted in Category [4] in the example here).
c. Category [3]: Natural product supplement recommendations—includes information of treatment recommendations for natural product food supplements as defined, for example, by the DSHEA in the USA and the definition of natural health product in Canada except homeopathic preparations.
d. Category [4]: Bioenergetic treatment and bioinformation treatment recommendations—includes information of treatment recommendations for unconventional, alternative and complementary medicine and healthcare treatment options. These include but are not limited to homeopathic medicine (classical homeopathy, complex homeopathy, electronically-derived homeopathy), acupuncture, electroacupuncture, focal hyperthermia, general hyperthermia, cold therapy, electro-dermal screening or electro-dermal assessment, bio-informational therapy and any direct or indirect electromagnetic, bioenergetic or bioinformational procedure, process or device providing electromagnetic information transfer, including, for example, light therapy, sound therapy, various electromagnetic frequency therapy and other massless information transfer therapy.
e. Category [5]: Physical activity recommendations—includes information of treatment recommendations for self-directed movement including and not limited to exercise, stretching, yoga, Pilates, resistance training, other exercise or training, and including and not limited to, for example, physical manipulation by health care practitioners, for example, chiropractic manipulation, physical therapy and massage therapy.
f. Category [6]: Mental, emotional, spiritual recommendations—includes information of treatment recommendations for improving intellectual, emotional, psychological, psychosocial, cultural and spiritual understanding, awareness, symptoms and management, including, as non-exclusive example, recommendations and guidelines for psychological, mental, emotional, behavioral, cognitive, intellectual, attitudinal, cultural and psychosocial treatment.
g. Category [7]: Environmental exposure recommendations—includes information of treatment recommendations for management of exposures to environmental stressors, infectious disease exposures in industrial, home and community settings, adverse sensory stimuli, toxins, irritants, adverse molecular exposure to airborne, surface, food, fluid contaminants and noxious matter in industrial, community and home settings, adverse electromagnetic radiation exposure in industrial, home and community settings and adverse physical exposure to potentially dangerous objects, machinery, technology, animals, parasite, molds, microbes, plants, chemicals and other adverse agents or dangerous materials or processes in industrial, community and home settings.

II. Cautions and Consents: Category 8
Category [8]: Precautions and consents recommendations—include relevant warnings about potential risks and adverse effects associated with various treatment recommendations, respectively, and recommendations for information creating valid patient-consumer consent documentation; including, as non-exclusive example, information for recommendations of precautions and cautions about potential adverse drug-drug interactions and other potential adverse effects from drugs and natural product supplements administered singly or in various combinations, treatment intolerances, allergies, other potential adverse effects and other warnings for medical and other treatment recommendations; and includes, for example, documentation for providing and obtaining valid consent for all treatment recommendations as necessary, indicated or desired, respectively.

III. Costs: Category 9
Category [9]: Cost consideration recommendations—includes expense and cost information. Due to the rising cost of treatment to patients and private and public payors, expenses associated with treatment option recommendations, if known or available, are provided for the relevant party payment planning. Each of the categories one through eight can impact the cost(s) of the treatment management plan(s).

In operation, the retriever device 208 queries the data source device 204, for example, over a network such as the Internet. Although a single data source device 204 is illustrated in FIG. 2, pluralities of similar data sources and related devices may be queried by the retriever device 208. In each instance, the data source device 204 (or other data source and related device) delivers to the retriever device 208 any recommendations available from the data source device 204 (and any relevant database 206) responsive to the query. Recommendations available from the data source device 204 relate to any one or more of the nine categories. Non-exclusive examples of the data source device 204 may include, but are not limited to, Omni medical search, NCBI, MedLine, PubMed, PMC, EBSCO, Health line, Health Finder, Cochrane, and others. Because the retriever device 208 obtains recommendations from a variety of sources, the specific information available from the relevant sources is integrated by the system 200 according to the nine categories and the system 200 yields integrated treatment management plan recommendations for all categories (rather than any single specific treatment recommendation that is provided by each unique data source device).

Upon retrieval of recommendations, the recommendations are communicated to the reader device 210. The reader device 210 translates the recommendations to a common language and/or syntax, as applicable. The common language recommendations are then parsed by the parser device 212 to extract and tag relevant recommendations. The tagged recommendations from the parser device 212 are stored in the database 216 by the segregator device 214, according to categories of the database 216.

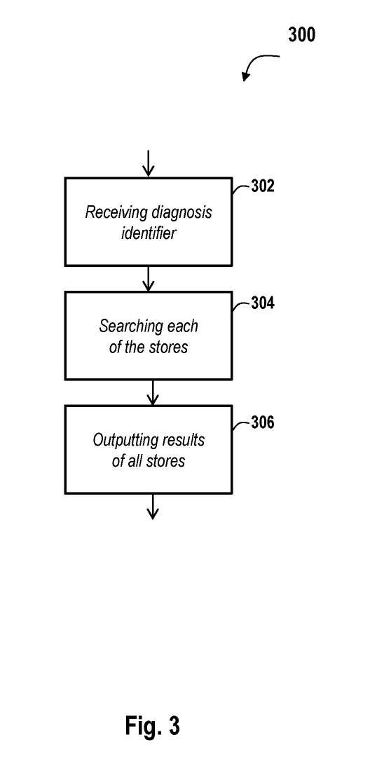

Referring to FIG. 3, a method 300 of treatment management includes a step of receiving 302 a diagnosis identifier by a processor. The diagnosis identifier may be input to the processor via an input device connected to the processor. According to certain non-exclusive embodiments, the diagnosis identifier is input to a template generated by the processor, such as a template viewable in a browser of a browser program processed by the processor.

Upon input of the diagnosis identifier, a step of searching 304 of each of a set of stores is performed by the processor. The stores include a dietary therapy store, a medical therapy store, a natural product supplement therapy store, a bioenergetics/bioinformation therapy store, a physical activity therapy store, an emotional therapy store, an environmental exposure therapy store, a precautions and consents store and a costs store. Examples of the stores include the stores 102, 104, 106, 108, 110, 112, 114, 116 and 118 of the system 100 of FIG. 1, however, these examples are non-exclusive and other, fewer or additional stores may be searched.

The step of searching 304 obtains specific and relevant treatment recommendations in multiple specific categories of the stores. The relevant treatment recommendations are multi-category, and are derived from the diagnosis(es) and health assessments organized according to the respective stores. In a step of outputting 306 results of the stores, the method 300 provides output of results of the step of searching 304 in an ordered, categorized manner for each of the stores and the specific diagnosis. The step of outputting 306, for example, delivers a printed or displayed categorical listing of treatment recommendations by an output device, such as a printer, display, browser, or other device.

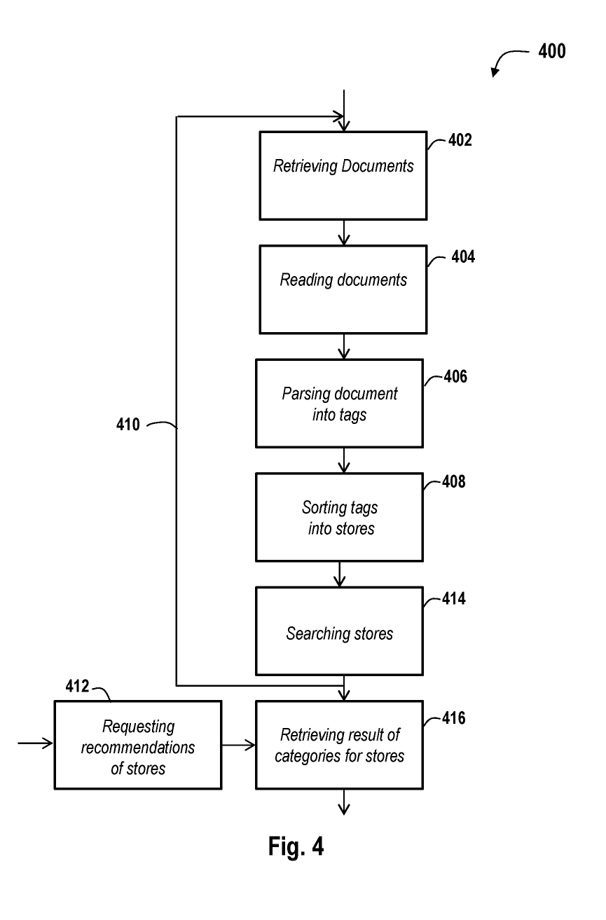

Referring to FIG. 4, a method 400 includes steps of the method 300. The method 400 includes a step of retrieving 402 documents of recommendations of treatment options. In the step 402, sources of treatment recommendations are accessed to obtain specific recommendations for treatment management from among a variety of treatment management options. The specific recommendations obtained in the step 402 are read in a step 404. The reading step 404 includes translation of the specific recommendations to common language and syntax. For example, the step of reading 404 may, but need not necessarily, include formatting of specific recommendations in a template or other format.

A step of parsing 406 the recommendations from the step of reading 404 includes tagging recommendations according to particular categories. The categories may, but need not necessarily, total nine categories, which categories represent a full range of multi-category treatment recommendations in seven categories, respectively, and one category for precautions and consents and one category for costs, respectively. Once tagged in the step of parsing 406, the tags are sorted into stores. Each store is a storage unit, for example, a database of respective categories or one or more individual stores each corresponding to respective category.

The method 400 continues 410, returning to the step 402. The steps 402, 404, 406, 408 and 410 of the method 400 may be performed continuously, intermittently, or according to schedule. As these steps are performed, numbers of the recommendations are increased in the database or other stores.

At any point in the method 400, the method 400 may proceed with a step of requesting 412 recommendations of the stores. In the step 412, input of a diagnosis(es) or other health assessment index or information is processed. The input may be via a template or other form, and may be performed by an input device, such as a keyboard, mouse, browser, touch display or similar device and a processor. Additionally, user selected filters may be input in the step 412.

Thereafter, a step of searching 414 the stores is performed for recommendations relevant to the input diagnosis. In the step 414, each of the stores is processed in respect of the input. For the specific input diagnosis, relevant recommendations of each of the stores are derived. The relevant recommendations are retrieved in a step 416 for each category of the stores. User selected filters of the step 412 may include/exclude certain categories or types of the recommendations. The retrieval step 416 may include output of the recommendations according to category. The output may be in form of a single, efficient, organized template of treatment recommendations available to any health care provider or payor, for a specific patient or client, multiple patients or clients, or groups of patients or clients, throughout a broad array of conventional and other health care options as (a) comprehensive treatment management plan(s).

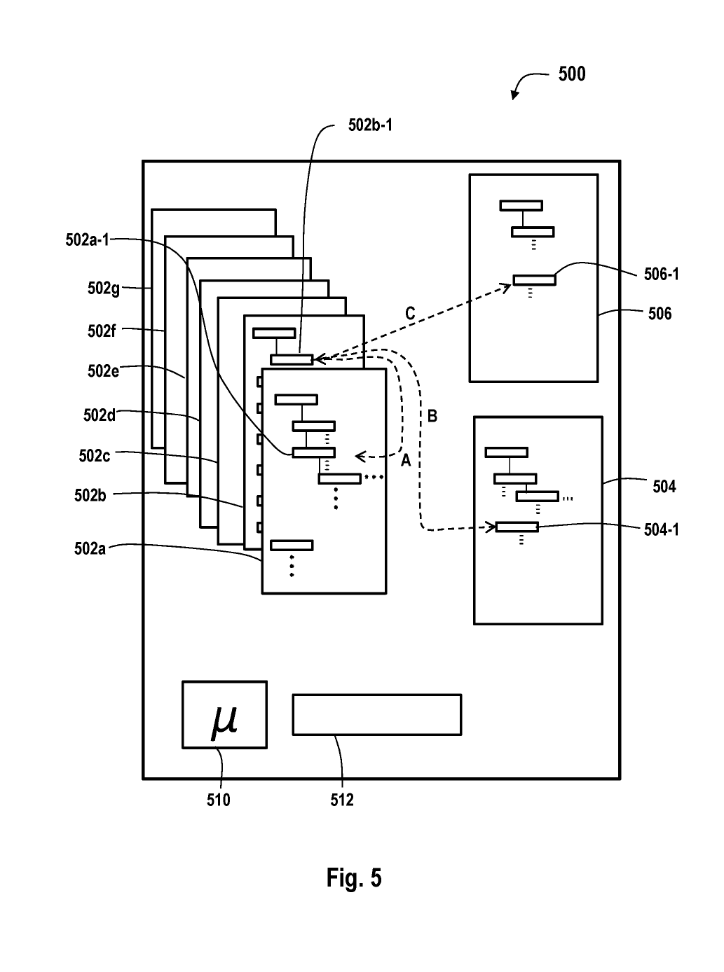

Referring to FIG. 5, a data storage and retrieval system 500 for delivering treatment management plans includes a plurality of stores 502a-g, 504, 506, each store of respective records, for example, 502a-1, 502b-1, 504-1, 506-1, is interrelated through respective tags corresponding the respective records to other of the respective records of the other of the stores, e.g., 502b-1, 502a-1; 502b-1, 504-1; and 502b-1, 506-1, respectively, as illustrated for example but not limitation by phantom arrows A, B and C. The stores 502a-g, 504, 506 include a dietary therapy store 502a, a medical therapy store 502b, a natural product supplement therapy store 502c, a bioenergetics/bioinformation therapy store 502d, a physical activity therapy store 502e, a mental and emotional therapy store 502f, and an environmental exposure therapy store 502g. The stores 502a-g, 504, 506 also include a precautions and consents store 504 and a costs store 506. Respective records of the precautions and consents store 504 and the costs store 506, respectively, relate to each of the respective records of the other stores 502a-g. Each of the respective records of the stores 502a-g, 504, 506 may include any number of subcategories or sub-records, and each subcategory or sub-record may further include sub-sub records in any hierarchical arrangement.

The data storage and retrieval system 500 includes a processor 510 communicatively connected to each of the stores 502a-g, 504, 506 and memory 512. The processor 510, upon input thereto of a disease identifier, in conjunction with the memory 512, indexes each of the stores 502a-g, 504, 506 and corresponding records, sub-records (and additional sub-sub-categories or sub-sub records as applicable in the stores), for inferentially related ones of the respective records, sub-records, etc. corresponding to the input disease identifier. On indexing by the processor 510, the processor 510 obtains respective records (and as applicable, sub-records, sub-sub records, etc.) corresponding to the particular disease identifier. These respective records include data of seven respective categories of treatment recommendations, together with one category of precautions and consents and one category of applicable costs corresponding to the treatment recommendations, respectively. The processor 510 may output the respective records of the seven, plus two, categories, such as via communicatively connected output devices for playing video, playing audio, imaging, displaying text, displaying graphics, print media, and any combination.

In certain of the foregoing embodiments, sources of recommendations include online medical search engines and sources of medical and scientific literature. Further in certain embodiments, human medical treatment management plans, as well as non-human treatment management plans, are possible. All treatment option recommendations may include, and are not limited to, medical (i.e., conventional medicine) treatment, integrative medicine treatment, complementary medicine treatment, alternative medicine treatment, osteopathic medicine treatment, chiropractic treatment, acupuncture treatment, naturopathic treatment, traditional and cultural-based health care, dental care, physical therapy, massage therapy and other bodywork care, psychological care, allied health care and independent health care provider recommendations, precautions and consents, and relevant costs.

Although output results include recommendations from all categories, it is possible that only certain categories represented in output result will be utilized by user of the embodiments. It is also possible that fewer or more categories are employed or searched in the embodiments, in which case output results will be similarly reflected. Non-exclusive examples include limitations or circumstances of financial limitations, availability of pharmaceutical, medical, surgical and other treatment options, health care consumer tolerability, risk factors, urgency, approval by payor, or consumer or patient acceptance. The physician, patient, client or other user may decide to implement or employ (or not) any recommendation of the output result. In circumstances where certain categories are not used, the recommendations of the category may include null set content. Formatting of output remains categorical, however, certain categories may contain the empty (null) set and a placeholder specification may appear in output results for the empty set. Alternately, fewer number of categories may be provided in output results, if any category(ies) is inapplicable per the user request, preference or restriction due to professional, commercial or other requirements.

In certain alternatives, the systems and methods are incorporated, in whole or part, as a data processing service performed by a data storage and retrieval system. For example, requests for any particular diagnosis may be input to a browser associated with a processor and stores. The browser may access the processor and stores through a graphical or other interface displayed in the browser responsive to request over the Internet or another network.

In other alternatives, the systems and methods are incorporated, in whole or part, in or with any electronic medical records (EMRs), electronic health records (EHRs), personal/patient health records (PHRs), or other electronic health care records. The system and methods can be employed in or with existing (or future) electronic healthcare/medical record systems.

In yet other alternatives, input of requests to the systems and methods may include prioritizations of, or among, treatment management plan selections. For example, input may prioritize cost, medication availability, physician availability, patient preference, and other prioritization factors. Similarly, any null set of category outputs may be filled by designated or rule based order, or according to preferences selected or required by the user.

In other alternatives, output results include hyperlinks or other links, including and not limited to relevant supporting information for treatment recommendations.

In the foregoing, the invention has been described with reference to specific embodiments. One of ordinary skill in the art will appreciate, however, that various modifications, substitutions, deletions, and additions can be made without departing from the scope of the invention. Accordingly, the specification and figures are to be regarded in an illustrative rather than a restrictive sense, and all such modifications substitutions, deletions, and additions are intended to be included within the scope of the invention. Any benefits, advantages, or solutions to problems that may have been described above with regard to specific embodiments, as well as device(s), connection(s), step(s) and element(s) that may cause any benefit, advantage, or solution to occur or become more pronounced, are not to be construed as a critical, required, or essential feature or element.

What is claimed is:

1. A system for optimizing delivery of a treatment management plan, comprising:
a dietary therapy store;
a medical therapy store;
a natural product supplement therapy store;
a bioenergetics/bioinformation therapy store;
a physical activity therapy store;
a mental and emotional therapy store;
an environmental exposure therapy store;
a precautions and consents store;
a costs store;
a store processor communicatively connected to the dietary therapy store, the medical therapy store, the natural product supplement therapy store, the bioenergetics/bioinformation therapy store, the physical activity therapy store, the mental and emotional therapy store, the environmental exposure therapy store, the precautions and consents store, and the costs store; and
memory communicatively connected to the store processor.

2. The system of claim 1, further comprising:
an input device communicatively connected to the store processor for receiving an identifier of a diagnosis; and
an output device communicatively connected to the store processor for reporting the treatment management plan.

3. A system for delivering a treatment management plan, treatment options for the plan are available from at least one data source device, comprising:
a retriever device communicatively connected to each of the at least one data source device accesses treatment recommendations of the at least one data source device;
a reader device communicatively connected to the retriever device translates the treatment recommendations from the retriever device to common language and syntax format;
a parser device communicatively connected to the reader device assigns respective tags to the treatment recommendations, respectively, the tags, respectively, correspond to pluralities of stores, respectively;
a segregator device communicatively connected to the parser device stores the tags, respectively, in corresponding ones of the stores, respectively; and
a database communicatively connected to the segregator devices includes the plurality of stores.

4. The system of claim 3, further comprising:
a communications network communicatively connected to the retriever device and the at least one data source device, wherein the retriever device searches the at least one data source device via the communications network for recommendations.

5. The system of claim 3, further comprising:
a scheduler device communicatively connected to the retriever device for triggering the retriever device to search the at least one data source device from time-to-time.

6. The system of claim 3, wherein the reader device includes a template for format of recommendations from the retriever device.

7. The system of claim 3, wherein the plurality of stores includes:
a dietary therapy store;
a medical therapy store;
a natural product supplement therapy store;
bioenergetics/bioinformation therapy store;
physical activity therapy store;
a mental and emotional therapy store;
an environmental exposure therapy store;
a precautions and consents store; and
a costs store.

8. The system of claim 7, further comprising:
a store processor communicatively connected to the dietary therapy store, the medical therapy store, the natural product supplement therapy store, the bioenergetics/bioinformation therapy store, the physical activity therapy store, the mental and emotional therapy store, the environmental exposure therapy store, the precautions and consents store, and the costs store; and
memory communicatively connected to the store processor.

9. The system of claim 3, further comprising:
a store processor communicatively connected to the plurality of stores; and
memory communicatively connected to the store processor.

10. A method of optimizing delivery of a treatment management plan, comprising:
receiving an input identifier of a diagnosis by a store processor;
processing by the store processor each of a dietary therapy store, a medical therapy store, a natural product supplement therapy store, a bioenergetics/bioinformation therapy store, a physical activity therapy store, a mental and emotional therapy store, an environmental exposure therapy store, a precautions and consents store, and a costs store, to determine recommendations of each store; and
outputting by the store processor the treatment management plan formatted by categories of each store.

11. The method of claim 10, further comprising:
supplying by the store processor recommendations, respectively, to the dietary therapy store, the medical therapy store, the natural product supplement therapy store, the bioenergetics/bioinformation therapy store, the physical activity therapy store, the mental and emotional therapy store, the environmental exposure therapy store, the precautions and consents store, and the costs store, respectively.

12. The method of claim 11, wherein the step of supplying by the store processor recommendations includes:
retrieving by the store processor from at least one data source device, over a communications network communicatively connected to the store processor and the at least one data source device, treatment recommendations of the at least one data source device;
translating by the store processor the treatment recommendations to common language and syntax format;
parsing by the store processor the treatment recommendations from the step of translating to assign respective tags to the treatment recommendations, respectively;
storing the tags, respectively, by the store processor, in each corresponding one of the dietary therapy store, the medical therapy store, the natural product supplement therapy store, the bioenergetics/bioinformation therapy store, the physical activity therapy store, the mental and emotional therapy store, the environmental exposure therapy store, the precautions and consents store, and the costs store, respectively.

13. The method of claim 12, further comprising:
scheduling by the store processor the step of retrieving;
wherein the steps of translating, parsing and storing occur on each step of retrieving.

14. The method of claim 10, further comprising:
providing an app for performing the steps of receiving, processing and outputting to records selected from the group consisting of: electronic medical records (EMRs), electronic health records (EHRs), personal/patient health records (PHRs), payor database, public database, private database, treatment recommendation database and any combination.

15. The method of claim 10, further comprising:
inputting by an input device communicatively connected to the communications network, the identifier of the diagnosis via a template in a browser of the input device.

16. The method of claim 10, wherein the step of outputting the treatment plan is selected from the group consisting of: playing video, playing audio, imaging, displaying text, displaying graphics, print media, and any combination.

17. A method of delivering a treatment management plan, comprising:
retrieving by a processor from at least one data source device, over a communications network communicatively connected to the at least one data source device and the processor, treatment recommendations of the at least one data source device;
translating by the processor the treatment recommendations to common language and syntax format;
parsing by the processor the treatment recommendations from the step of translating to assign respective tags to the treatment recommendations, respectively; and
storing the tags, respectively, by the processor, in each corresponding one of a dietary therapy store, a medical therapy store, a natural product supplement therapy store, a bioenergetics/bioinformation therapy store, a physical activity therapy store, a mental and emotional therapy store, an environmental exposure therapy store, a precautions and consents store, and a costs store, respectively.

18. The method of claim 17, further comprising:
receiving an input identifier of a diagnosis by the processor;
processing by the processor each of the dietary therapy store, the medical therapy store, the natural product supplement therapy store, the bioenergetics/bioinformation therapy store, the physical activity therapy store, the mental and emotional therapy store, the environmental exposure therapy store, the precautions and consents store, and the costs store, to determine recommendations of each store; and
outputting by the processor the treatment management plan formatted by categories of each store, respectively.

19. The method of claim 18, further comprising:
inputting by a device communicatively connected by the communications network to the processor, the identifier of the diagnosis via a template in a browser of the device.

20. The method of claim 18, wherein the step of outputting the treatment plan is selected from the group consisting of: playing video, playing audio, imaging, displaying text, displaying graphics, print media, and any combination.

21. A data storage and retrieval system for a computer memory, for delivering a treatment management plan, comprising:
a dietary therapy store;
a medical therapy store;
a natural product supplement therapy store;
a bioenergetics/bioinformation therapy store;
a physical activity therapy store;
a mental and emotional therapy store;
an environmental exposure therapy store;
a precautions and consents store;
a costs store;
wherein each of the dietary therapy store, the medical therapy store, the natural product supplement therapy store, the bioenergetics/bioinformation therapy store, the physical activity therapy store, the mental and emotional therapy store, the environmental exposure therapy store, the precautions and consents store, and the costs store includes a plurality of respective records, which respective records are inferentially related to other of the plurality of respective records of others of the dietary therapy store, the medical therapy store, the natural product supplement therapy store, the bioenergetics/bioinformation therapy store, the physical activity therapy store, the mental and emotional therapy store, the environmental exposure therapy store, the precautions and consents store, and the costs store;
a store processor communicatively connected to the dietary therapy store, the medical therapy store, the natural product supplement therapy store, the bioenergetics/bioinformation therapy store, the physical activity therapy store, the mental and emotional therapy store, the environmental exposure therapy store, the precautions and consents store, and the costs store, the store processor indexes respective records of each of the dietary therapy store, the medical therapy store, the natural product supplement therapy store, the bioenergetics/bioinformation therapy store, the physical activity therapy store, the mental and emotional therapy store, the environmental exposure therapy store, the precautions and consents store, and the costs store, according to inferential relationship of the respective records; and
memory communicatively connected to the store processor.
